(19) United States
(12) Patent Application Publication
(10) Pub. No.: US 2012/0311444 A1
(43) Pub. Date: Dec. 6, 2012

(54) PORTABLE MULTIFUNCTION DEVICE, METHOD, AND GRAPHICAL USER INTERFACE FOR CONTROLLING MEDIA PLAYBACK USING GESTURES

(75) Inventor: Imran A. Chaudhri, San Francisco, CA (US)

(73) Assignee: Apple Inc., Cupertino, CA (US)

(21) Appl. No.: 13/489,245

(22) Filed: Jun. 5, 2012

Related U.S. Application Data
(60) Provisional application No. 61/493,483, filed on Jun. 5, 2011.

(51) Int. Cl. G06F 3/048; G06F 3/041

(52) U.S. Cl. 715/716

(57) ABSTRACT

A collection of media tiles associated with a currently playing playlist can be displayed for a user on the screen of an electronic device. Browsing through the media tiles can require a user to perform one or more quick view gestures, including swiping, dragging, or walking. As long as a user continues to perform quick view gestures, the currently playing media file may continue to play. While the user continues to perform quick view gestures, the device can be considered to be in a quick view gesture mode in which the currently playing media file is not disrupted. A user may discontinue using quick view gestures (and thereby, quick view gesture mode) upon reaching a particular media tile. After a predetermined length of time, the media file associated with that media tile can automatically begin to play.

### CROSS-REFERENCE TO RELATED APPLICATIONS

This application claims the benefit of U.S. Provisional Patent Application No. 61/493,483, filed Jun. 5, 2011, which is incorporated by reference herein in its entirety.

### TECHNICAL FIELD

The disclosed embodiments relate generally to controlling portable electronic devices, and more particularly, to controlling media playback on a portable device using gestures.

### BACKGROUND

As portable electronic devices become more compact, and the number of functions performed by a given device increases, it has become a significant challenge to design a user interface that allows users to easily interact with a multifunction device. This challenge is particularly significant for handheld portable devices, which have much smaller screens than desktop or laptop computers. This situation is unfortunate because the user interface is the gateway through which users receive not only content but also responses to user actions or behaviors, including user attempts to access a device's features, tools, and functions. Some portable communication devices (e.g., mobile telephones, sometimes called mobile phones, cell phones, cellular telephones, and the like) have resorted to adding more pushbuttons, increasing the density of push buttons, overloading the functions of pushbuttons, or using complex menu systems to allow a user to access, store and manipulate data. These conventional user interfaces often result in complicated key sequences and menu hierarchies that must be memorized by the user.

Many conventional user interfaces, such as those that include physical pushbuttons, are also inflexible. This is unfortunate because it may prevent a user interface from being configured and/or adapted by either an application running on the portable device or by users. When coupled with the time consuming requirement to memorize multiple key sequences and menu hierarchies, and the difficulty in activating a desired pushbutton, such inflexibility can be frustrating to many users.

User interfaces associated with modern media players can be very unintuitive. Users with digital libraries are not provided with the visceral experience of physically picking out a record and choosing a track to play. Media player interfaces that do provide views of an album's artwork fail to be intuitive and user friendly. Accordingly, there is a need for portable multifunction devices with more transparent and intuitive user interfaces for controlling media playback.

### SUMMARY

The above deficiencies and other problems associated with user interfaces for portable devices are reduced or eliminated by the disclosed portable multifunction device. According to some embodiments, a user can browse through a collection of media tiles associated with media files (e.g., songs) in a currently playing playlist. The media tiles may be album art associated with the media files, for example. Browsing through the media tiles may require a user to perform one or more quick view gestures (i.e., intuitive user input commands) to scroll between media tiles. As long as a user continues to perform quick view gestures, the currently playing media file may continue to play. While the user continues to perform quick view gestures, the device can be considered to be in a “quick view gesture mode” in which the currently playing media file is not disrupted. However, if the user stops using quick view gestures (and thereby exits the quick view gesture mode) for predetermined length of time, the media file associated with the then-displayed media tile can automatically begin to play.

According to some embodiments, a portable multifunction device for controlling media playback using gestures may include a display and one or more programs for playing back a selected media file from a playlist, where each media file in the playlist is associated with a media tile. The media tile associated with the selected media file may be displayed on the display while that media file is playing. If the device receives one or more quick view gestures, however, the media tile being displayed may change to the media tile associated with the previous or next media file in the playlist (e.g., based on the type of quick view gesture). Playback of the selected media file can continue as long as the device receives quick view gestures. However, once quick view gestures are no longer being received, the device can begin to automatically playback the media file associated with the then-displayed media tile.

In further embodiments a method for controlling media playback using gestures may include providing a playlist of tracks in which each track is associated with an album art cover on a device. A track may be initially selected for playback. If the device receives a quick view gesture (e.g., a swipe on a touch-sensitive display), the device can enter a quick view gesture input mode that allows the user to view album covers of other tracks in the playlist. The device can then automatically play back the track corresponding to the album cover being displayed when the quick view gesture input mode ends.

### BRIEF DESCRIPTION OF THE DRAWINGS

For a better understanding of the aforementioned embodiments of the invention as well as additional embodiments thereof, reference should be made to the Description of Embodiments below, in conjunction with the following drawings in which like reference numerals refer to corresponding parts throughout the figures.

FIG. 1 is a block diagram illustrating a portable multifunction device with a touch-sensitive display in accordance with some embodiments.

FIG. 2 is a block diagram illustrating an exemplary API architecture, which may be used in some embodiments of the invention.

FIG. 3 is a block diagram illustrating an exemplary API architecture, which may be used in some embodiments of the invention.

FIG. 4 illustrates a portable multifunction device having a touch screen in accordance with some embodiments.

FIG. 5 illustrates an exemplary user interface for controlling media playback on a portable electronic device in accordance with some embodiments.

FIG. 6A-C illustrate exemplary user interfaces for controlling media playback on a portable electronic device in accordance with some embodiments.

FIG. 7 is a flow diagram illustrating process for controlling media playback on a portable electronic device in accordance with some embodiments.

### DETAILED DESCRIPTION OF THE DISCLOSURE

Reference will now be made in detail to embodiments, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known methods, procedures, components, circuits, and networks have not been described in detail so as not to unnecessarily obscure aspects of the embodiments.

According to some embodiments, a media file can be selected and played back from a media playlist on an electronic device. The playlist may be completely or partially user generated and can include any suitable type of media files. For example, the playlist can include audio files, video files, still images, and/or combinations of the above. Files in a playlist may be set to play in a predetermined order or can be shuffled (i.e., played back in a randomized or semi-randomized order).

In some embodiments, a graphic representation of the currently playing media file can be displayed for the user. In the event that the current playing media file is an audio file (e.g., a song), the graphic representation may include, among other things, a view of the album art associated with the particular audio file, the song name, artist, and album. The graphic representation can also include a status bar indicating the progress through the currently playing media file. As used to herein, the elements making up a graphic representation of a media file can be collectively referred to as a “media tile.” In some embodiments, media tiles can be generated for all files in the media playlist in addition to the currently playing media file. In that case, the media tiles may be viewed in an “album-art mode” in which the media tiles are queued in the same order as the playlist. Once a media tile has been created for a particular media file, it may be stored in memory for future use. In album-art mode, each media tile can be displayed in full-screen mode with the other media files being accessible by scrolling (e.g., side to side). In other embodiments, media tiles may be displayed in less than full-screen mode and/or with multiple media tiles displayed at once.

Media tiles can also be created for video files. Video media tiles can include cover art representative of the video file or, if no cover art exists, a screen shot or short clip from the video file may be displayed in the media tile. Key identifying information about the video file can also be included in the media tile.

The device may enter a quick view gesture mode upon receiving a quick view gesture. In quick view gesture mode a user may be permitted to scroll through the media tiles that are displayed when the device is in album-art mode without disrupting the currently playing media file. An example of a quick view gesture may be placing a finger on a touch screen of the electronic device and dragging it sideways (i.e., left to right or right to left). In response, the display can scroll in the same direction and at the same pace, bringing the next (or previous, depending on the direction of the quick view gesture) media tile into view. Using a dragging gesture, the user may be able to quickly peek at the next or previous media tiles without disrupting the currently playing media file. Once a user exits quick view gesture mode (e.g., by lifting a finger off of the device for a predetermined period of time), the device may begin to play the media file associated with the currently displayed media tile.

Embodiments of a portable multifunction device, user interfaces for such devices, and associated processes for using such devices are described. In some embodiments, the device is a portable communications device such as a mobile telephone that also contains other functions, such as PDA and/or music player functions.

The user interface may include a physical click wheel in addition to a touch screen or a virtual click wheel displayed on the touch screen. A click wheel is a user-interface device that may provide navigation commands based on an angular displacement of the wheel or a point of contact with the wheel by a user of the device. A click wheel may also be used to provide a user command corresponding to selection of one or more items, for example, when the user of the device presses down on at least a portion of the wheel or the center of the wheel. Alternatively, breaking contact with a click wheel image on a touch screen surface may indicate a user command corresponding to selection. For simplicity, in the discussion that follows, a portable multifunction device that includes a touch screen is used as an exemplary embodiment. It should be understood, however, that some of the user interfaces and associated processes may be applied to other devices, such as personal computers and laptop computers, that may include one or more other physical user-interface devices, such as a physical click wheel, a physical keyboard, a mouse and/or a joystick.

The device supports a variety of applications, such as a telephone application, a video conferencing application, an e-mail application, an instant messaging application, a blogging application, a digital camera application, a digital video camera application, a web browsing application, a digital music player application, and/or a digital video player application.

The various applications that may be executed on the device may use at least one common physical user-interface device, such as the touch screen. One or more functions of the touch screen as well as corresponding information displayed on the device may be adjusted and/or varied from one application to the next and/or within a respective application. In this way, a common physical architecture (such as the touch screen) of the device may support the variety of applications with user interfaces that are intuitive and transparent.

The user interfaces may include one or more soft keyboard embodiments. The soft keyboard embodiments may include standard (QWERTY) and/or non-standard configurations of symbols on the displayed icons of the keyboard, such as those described in U.S. Pat. No. 7,694,231, “Keyboards For Portable Electronic Devices,” issued Apr. 6, 2010, and U.S. Patent Publication No. 2007/0152980, “Touch Screen Keyboards For Portable Electronic Devices,” published Jul. 5, 2007, the contents of which are hereby incorporated by reference. The keyboard embodiments may include a reduced number of icons (or soft keys) relative to the number of keys in existing physical keyboards, such as that for a typewriter. This may make it easier for users to select one or more icons in the keyboard, and thus, one or more corresponding symbols. The keyboard embodiments may be adaptive. For example, displayed icons may be modified in accordance with user actions, such as selecting one or more icons and/or one or more corresponding symbols. One or more applications on the portable device may utilize common and/or different keyboard embodiments. Thus, the keyboard embodiment used may be tailored to at least some of the applications. In some embodiments, one or more keyboard embodiments may be tailored to a respective user. For example, a keyboard embodiment may be based on a word usage history (lexicography, slang, individual usage) of the respective user. Some of the keyboard embodiments may be adjusted to reduce a probability of a user error when selecting one or more icons, and thus one or more symbols, when using the soft keyboard embodiments.

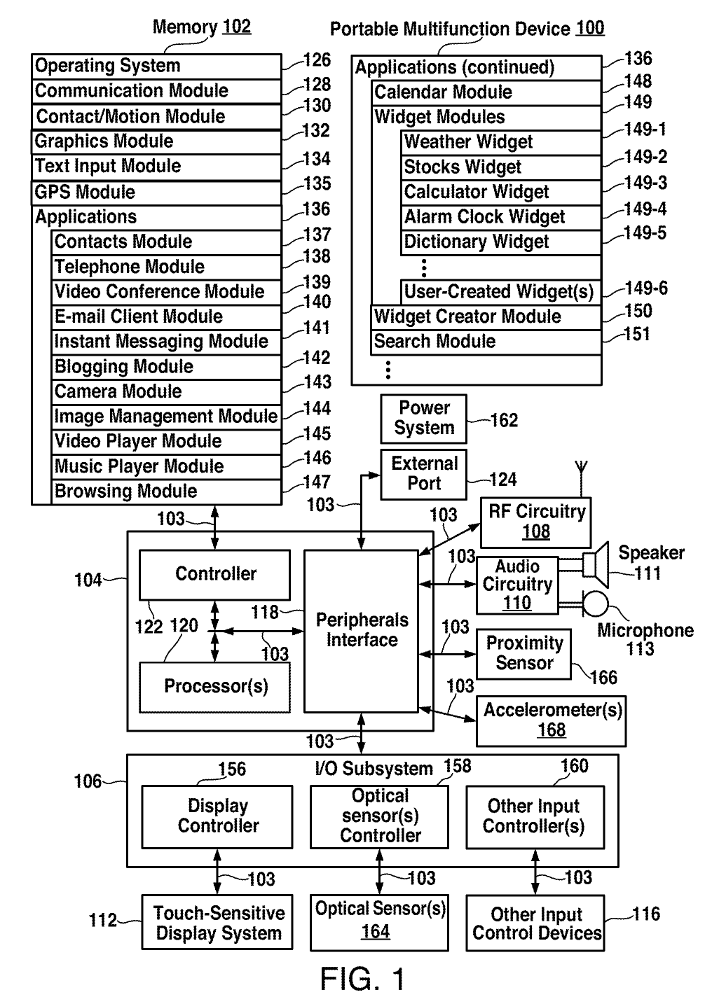

Attention is now directed towards embodiments of the device. FIG. 1 is a block diagram illustrating a portable multifunction device 100 with a touch-sensitive display 112 in accordance with some embodiments. The touch-sensitive display 112 is sometimes called a “touch screen” for convenience, and may also be known as or called a touch-sensitive display system. Device 100 may include memory 102 (which may include one or more computer readable storage mediums), memory controller 122, one or more processing units (CPUs) 120, peripherals interface 118, RF circuitry 108, audio circuitry 110, speaker 111, microphone 113, input/output (I/O) subsystem 106, other input or control devices 116, and external port 124. Device 100 may include one or more optical sensors 164. These components may communicate over one or more communication buses or signal lines 103.

It should be appreciated that device 100 is only one example of a portable multifunction device, and that the device 100 may have more or fewer components than shown, may combine two or more components, or a may have a different configuration or arrangement of the components. The various components shown in FIG. 1 may be implemented in hardware, software or a combination of both hardware and software, including one or more signal processing and/or application specific integrated circuits.

Memory 102 may include high-speed random access memory and may also include non-volatile memory, such as one or more magnetic disk storage devices, flash memory devices, or other non-volatile solid-state memory devices. Access to memory 102 by other components of the device 100, such as the CPU 120 and the peripherals interface 118, may be controlled by the memory controller 122.

The peripherals interface 118 couples the input and output peripherals of the device to CPU 120 and memory 102. The one or more processors 120 run or execute various software programs and/or sets of instructions stored in memory 102 to perform various functions for device 100 and to process data.

In some embodiments, peripherals interface 118, CPU 120, and memory controller 122 may be implemented on a single chip, such as chip 104. In some other embodiments, they may be implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 may include well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 may communicate with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication may use any of a plurality of communications standards, protocols and technologies, including but not limited to Global System for Mobile Communications (GSM), Enhanced Data GSM Environment (EDGE), high-speed downlink packet access (HSDPA), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), and/or Instant Messaging and Presence Service (IMPS)), and/or Short Message Service (SMS)), or any other suitable communication protocol, including communication protocols not yet developed as of the filing date of this document.

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data may be retrieved from and/or transmitted to memory 102 and/or RF circuitry 108 by peripherals interface 118. In some embodiments, audio circuitry 110 also includes a headset jack (not shown). The headset jack provides an interface between audio circuitry 110 and removable audio input/output peripherals, such as output-only headphones or a headset with both output (e.g., a headphone for one or both ears) and input (e.g., a microphone).

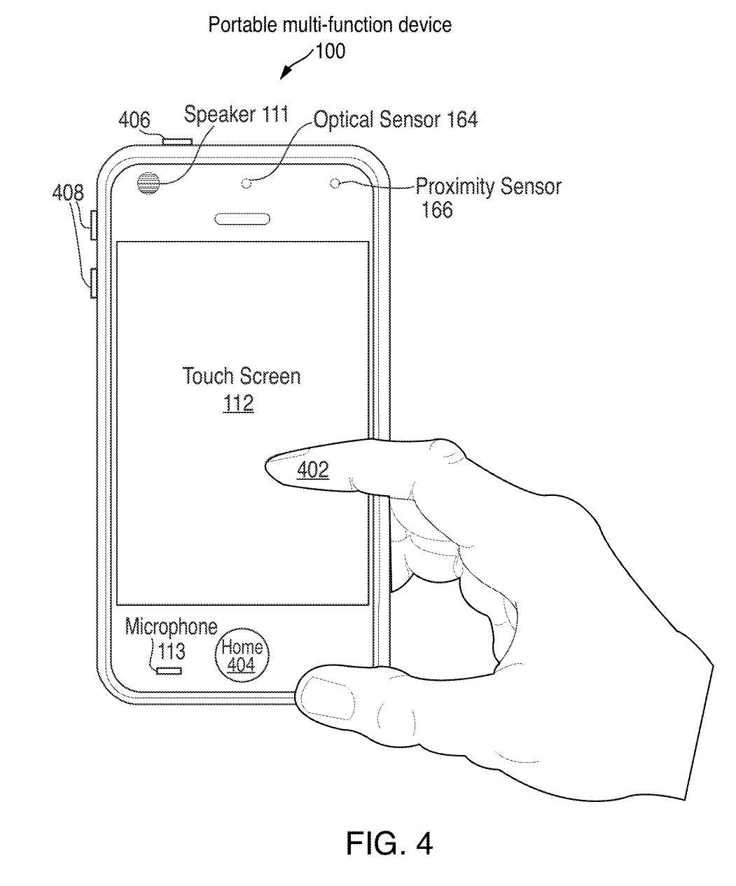

I/O subsystem 106 couples input/output peripherals on device 100, such as touch screen 112 and other input/control devices 116, to peripherals interface 118. I/O subsystem 106 may include display controller 156 and one or more input controllers 160 for other input or control devices. The one or more input controllers 160 receive/send electrical signals from/to other input or control devices 116. The other input/control devices 116 may include physical buttons (e.g., push buttons, rocker buttons, etc.), dials, slider switches, joysticks, click wheels, and so forth. In some alternate embodiments, input controller(s) 160 may be coupled to any (or none) of the following: a keyboard, infrared port, USB port, and a pointer device such as a mouse. The one or more buttons (e.g., buttons 408 of FIG. 4) may include an up/down button for volume control of speaker 111 and/or microphone 113. The one or more buttons may include a push button (e.g., button 406 of FIG. 4). A quick press of the push button may disengage a lock of the touch screen 112 or begin a process that uses gestures on the touch screen to unlock the device, as described in U.S. Pat. No. 7,657,849, “Unlocking a Device by Performing Gestures on an Unlock Image,” issued Feb. 2, 2010, which is hereby incorporated by reference. A longer press of the push button (e.g., 406) may turn power to the device 100 on or off. The user may be able to customize a functionality of one or more of the buttons. The touch screen 112 is used to implement virtual or soft buttons and one or more soft keyboards.

Touch-sensitive touch screen 112 provides an input interface and an output interface between the device and a user. Display controller 156 receives and/or sends electrical signals from/to the touch screen 112. Touch screen 112 displays visual output to the user. The visual output may include graphics, text, icons, video, and any combination thereof (collectively termed “graphics”). In some embodiments, some or all of the visual output may correspond to user-interface objects, further details of which are described below.

Touch screen 112 has a touch-sensitive surface, sensor or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and converts the detected contact into interaction with user-interface objects (e.g., one or more soft keys, icons, web pages or images) that are displayed on the touch screen. In an exemplary embodiment, a point of contact between touch screen 112 and the user corresponds to a finger of the user.

Touch screen 112 may use LCD (liquid crystal display) technology, or LPD (light emitting polymer display) technology, although other display technologies may be used in other embodiments. Touch screen 112 and display controller 156 may detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. A touch-sensitive display in some embodiments of touch screen 112 may be analogous to the multi-touch sensitive tablets described in the following U.S. Pat. Nos. 6,323,846 (Westerman et al.), 6,570,557 (Westerman et al.), and/or 6,677,932 (Westerman), and/or U.S. Patent Publication 2002/0015024A1 (Westerman et al.), each of which is hereby incorporated by reference. However, touch screen 112 displays visual output from portable device 100, whereas touch sensitive tablets do not provide visual output. Touch screen 112 may have a resolution in excess of 100 dpi. In an exemplary embodiment, the touch screen in the display system has a resolution of approximately 168 dpi. The user may make contact with touch screen 112 using any suitable object or appendage, such as a stylus, a finger, and so forth. In some embodiments, the user interface is designed to work primarily with finger-based contacts and gestures, which are much less precise than stylus-based input due to the larger area of contact of a finger on the touch screen. In some embodiments, the device translates the rough finger-based input into a precise pointer/cursor position or command for performing the actions desired by the user.

A touch-sensitive display in some embodiments of touch screen 112 may be as described in the following applications: (1) U.S. Patent Publication No. 2007/0257890, “Multipoint Touch Surface Controller,” published on Nov. 8, 2007; (2) U.S. Pat. No. 7,663,607, “Multipoint Touchscreen,” issued on Feb. 16, 2010; (3) U.S. Patent Publication No. 2006-0026521, “Gestures For Touch Sensitive Input Devices,” published on Feb. 2, 2006; (4) U.S. Patent Application No. 2006/0026536, “Gestures For Touch Sensitive Input Devices,” published on Feb. 2, 2006; (5) U.S. Patent Publication No. 2006/0026535, “Mode-Based Graphical User Interfaces For Touch Sensitive Input Devices,” published on Feb. 2, 2006; (6) U.S. Patent Publication No. 2006/0033724, “Virtual Input Device Placement On A Touch Screen User Interface,” published on Feb. 16, 2006; (7) U.S. Pat. No. 7,614,008, “Operation Of A Computer With A Touch Screen Interface,” issued on Nov. 3, 2009; (8) U.S. Pat. No. 7,844,914, “Activating Virtual Keys Of A Touch-Screen Virtual Keyboard,” issued on Nov. 30, 2010; and (9) U.S. Patent Publication No. 2006/0197753, “Multi-Functional Hand-Held Device,” published on Sep. 7, 2006. All of these applications are incorporated by reference herein.

In some embodiments, in addition to the touch screen, device 100 may include a touchpad (not shown) for activating or deactivating particular functions. In some embodiments, the touchpad is a touch-sensitive area of the device that, unlike the touch screen, does not display visual output. The touchpad may be a touch-sensitive surface that is separate from touch screen 112 or an extension of the touch-sensitive surface formed by the touch screen.

In some embodiments, device 100 may include a physical or virtual click wheel as an input control device 116. A user may navigate among and interact with one or more graphical objects (henceforth referred to as icons) displayed in touch screen 112 by rotating the click wheel or by moving a point of contact with the click wheel (e.g., where the amount of movement of the point of contact is measured by its angular displacement with respect to a center point of the click wheel). The click wheel may also be used to select one or more of the displayed icons. For example, the user may press down on at least a portion of the click wheel or an associated button. User commands and navigation commands provided via the click wheel may be processed by input controller 160, as well as one or more of the modules and/or sets of instructions in memory 102. For a virtual click wheel, the click wheel and click wheel controller may be part of the touch screen 112 and the display controller 156, respectively. For a virtual click wheel, the click wheel may be either an opaque or semitransparent object that appears and disappears on the touch screen display in response to user interaction with the device. In some embodiments, a virtual click wheel is displayed on the touch screen of a portable multifunction device and operated by user contact with the touch screen.

Device 100 also includes power system 162 for powering the various components. Power system 162 may include a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 may also include one or more optical sensors 164. FIG. 1 shows an optical sensor coupled to optical sensor controller 158 in I/O subsystem 106. Optical sensor 164 may include charge-coupled device (CCD) or complementary metal-oxide semiconductor (CMOS) phototransistors. Optical sensor 164 receives light from the environment projected through one or more lens, and converts the light to data representing an image. In conjunction with imaging module 143 (also called a camera module), optical sensor 164 may capture still images or video. In some embodiments, an optical sensor is located on the back of device 100, opposite touch screen display 112 on the front of the device, so that the touch screen display may be used as a viewfinder for either still and/or video image acquisition. In some embodiments, an optical sensor is located on the front of the device so that the user's image may be obtained for video conferencing while the user views the other video conference participants on the touch screen display. In some embodiments, the user can change the position of optical sensor 164 (e.g., by rotating the lens and the sensor in the device housing) so that a single optical sensor may be used along with the touch screen display for both video conferencing and still and/or video image acquisition.

Device 100 may also include one or more proximity sensors 166. FIG. 1 shows proximity sensor 166 coupled to peripherals interface 118. Alternately, proximity sensor 166 may be coupled to input controller 160 in I/O subsystem 106. Proximity sensor 166 may perform as described in U.S. Pat. No. 7,653,883, “Proximity Detector In Handheld Device,” issued Jan. 26, 2010, and U.S. Patent Publication No. 2006/0161870, “Proximity Detector In Handheld Device,” published Jul. 20, 2006, which are hereby incorporated by reference. In some embodiments, the proximity sensor turns off and disables touch screen 112 when the multifunction device is placed near the user's ear (e.g., when the user is making a phone call). In some embodiments, the proximity sensor keeps the screen off when the device is in the user's pocket, purse, or other dark area to prevent unnecessary battery drainage when the device is a locked state.

Device 100 may also include one or more accelerometers 168. FIG. 1 shows accelerometer 168 coupled to peripherals interface 118. Alternately, accelerometer 168 may be coupled to input controller 160 in I/O subsystem 106. Accelerometer 168 may perform as described in U.S. Patent Publication No. 2005/0190059, “Acceleration-based Theft Detection System for Portable Electronic Devices,” published on Sep. 1, 2005, and U.S. Patent Publication No. 2006/0017692, “Methods And Apparatuses For Operating A Portable Device Based On An Accelerometer,” published on Jan. 26, 2006, both of which are incorporated herein by reference. In some embodiments, information is displayed on the touch screen display in a portrait view or a landscape view based on an analysis of data received from the one or more accelerometers.

In some embodiments, the software components stored in memory 102 may include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or set of instructions) 136.

Operating system 126 (e.g., Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used on iPod (trademark of Apple Computer, Inc.) devices.

Contact/motion module 130 may detect contact with touch screen 112 (in conjunction with display controller 156) and other touch sensitive devices (e.g., a touchpad or physical click wheel). Contact/motion module 130 includes various software components for performing various operations related to detection of contact, such as determining if contact has occurred, determining if there is movement of the contact and tracking the movement across touch screen 112, and determining if the contact has been broken (i.e., if the contact has ceased). Determining movement of the point of contact may include determining speed (magnitude), velocity (magnitude and direction), and/or an acceleration (a change in magnitude and/or direction) of the point of contact. These operations may be applied to single contacts (e.g., one finger contacts) or to multiple simultaneous contacts (e.g., “multi-touch”/multiple finger contacts). In some embodiments, contact/motion module 130 and display controller 156 also detect contact on a touchpad. In some embodiments, contact/motion module 130 and controller 160 detect contact on a click wheel.

Graphics module 132 includes various known software components for rendering and displaying graphics on touch screen 112, including components for changing the intensity of graphics that are displayed. As used herein, the term “graphics” includes any object that can be displayed to a user, including without limitation text, web pages, icons (such as user-interface objects including soft keys), digital images, videos, animations and the like.

Text input module 134, which may be a component of graphics module 132, provides soft keyboards for entering text in various applications (e.g., contacts 137, email 140, IM 141, blogging 142, browser 147, and any other application that needs text input).

GPS module 135 determines the location of the device and provides this information for use in various applications (e.g., to telephone 138 for use in location-based dialing, to camera 143 and/or blogger 142 as picture/video metadata, and to applications that provide location-based services such as weather widgets, local yellow page widgets, and map/navigation widgets).

Applications 136 may include the following modules (or sets of instructions), or a subset or superset thereof:
contacts module 137 (sometimes called an address book or contact list);
telephone module 138;
video conferencing module 139;
e-mail client module 140;
instant messaging (IM) module 141;
blogging module 142;
camera module 143 for still and/or video images;
image management module 144;
video player module 145;
music player module 146;
browser module 147;
calendar module 148;
widget modules 149, which may include:
   weather widget 149-1;
   stocks widget 149-2;
   calculator widget 149-3;
   alarm clock widget 149-4;
   dictionary widget 149-5; and
   other widgets obtained by the user, as well as user-created widgets 149-6;
widget creator module 150 for making user-created widgets 149-6; and/or
search module 151.

Examples of other applications 136 that may be stored in memory 102 include a memo pad and other word processing applications, JAVA-enabled applications, encryption, digital rights management, voice recognition, and voice replication.

In conjunction with touch screen 112, display controller 156, contact module 130, graphics module 132, and text input module 134, contacts module 137 may be used to manage an address book or contact list, including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference 139, e-mail 140, or IM 141; and so forth.

In conjunction with RF circuitry 108, audio circuitry 110, speaker 111, microphone 113, touch screen 112, display controller 156, contact module 130, graphics module 132, and text input module 134, telephone module 138 may be used to enter a sequence of characters corresponding to a telephone number, access one or more telephone numbers in address book 137, modify a telephone number that has been entered, dial a respective telephone number, conduct a conversation and disconnect or hang up when the conversation is completed. As noted above, the wireless communication may use any of a plurality of communications standards, protocols and technologies.

In conjunction with RF circuitry 108, audio circuitry 110, speaker 111, microphone 113, touch screen 112, display controller 156, optical sensor 164, optical sensor controller 158, contact module 130, graphics module 132, text input module 134, contact list 137, and telephone module 138, video conferencing module 139 may be used to initiate, conduct, and terminate a video conference between a user and one or more other participants.

In conjunction with RF circuitry 108, touch screen 112, display controller 156, contact module 130, graphics module 132, and text input module 134, e-mail client module 140 may be used to create, send, receive, and manage e-mail. In conjunction with image management module 144, the e-mail module 140 makes it very easy to create and send e-mails with still or video images taken with camera module 143.

In conjunction with RF circuitry 108, touch screen 112, display controller 156, contact module 130, graphics module 132, and text input module 134, instant messaging module 141 may be used to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages and to view received instant messages. In some embodiments, transmitted and/or received instant messages may include graphics, photos, audio files, video files and/or other attachments as are supported in a MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact module 130, graphics module 132, text input module 134, image management module 144, and browsing module 147, blogging module 142 may be used to send text, still images, video, and/or other graphics to a blog (e.g., the user's blog).

In conjunction with touch screen 112, display controller 156, optical sensor(s) 164, optical sensor controller 158, contact module 130, graphics module 132, and image management module 144, camera module 143 may be used to capture still images or video (including a video stream) and store them into memory 102, modify characteristics of a still image or video, or delete a still image or video from memory 102.

In conjunction with touch screen 112, display controller 156, contact module 130, graphics module 132, text input module 134, and camera module 143, image management module 144 may be used to arrange, modify or otherwise manipulate, label, delete, present (e.g., in a digital slide show or album), and store still and/or video images.

In conjunction with touch screen 112, display controller 156, contact module 130, graphics module 132, audio circuitry 110, and speaker 111, video player module 145 may be used to display, present or otherwise play back videos (e.g., on the touch screen or on an external, connected display via external port 124).

In conjunction with touch screen 112, display system controller 156, contact module 130, graphics module 132, audio circuitry 110, speaker 111, RF circuitry 108, and browser module 147, music player module 146 allows the user to download and play back recorded music and other sound files stored in one or more file formats, such as MP3 or AAC files. In some embodiments, device 100 may include the functionality of an MP3 player, such as an iPod (trademark of Apple Computer, Inc.).

In conjunction with RF circuitry 108, touch screen 112, display system controller 156, contact module 130, graphics module 132, and text input module 134, browser module 147 may be used to browse the Internet, including searching, linking to, receiving, and displaying web pages or portions thereof, as well as attachments and other files linked to web pages.

In conjunction with RF circuitry 108, touch screen 112, display system controller 156, contact module 130, graphics module 132, text input module 134, e-mail module 140, and browser module 147, calendar module 148 may be used to create, display, modify, and store calendars and data associated with calendars (e.g., calendar entries, to do lists, etc.).

In conjunction with RF circuitry 108, touch screen 112, display system controller 156, contact module 130, graphics module 132, text input module 134, and browser module 147, widget modules 149 are mini-applications that may be downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display system controller 156, contact module 130, graphics module 132, text input module 134, and browser module 147, widget creator module 150 may be used by a user to create widgets (e.g., turning a user-specified portion of a web page into a widget).

In conjunction with touch screen 112, display system controller 156, contact module 130, graphics module 132, and text input module 134, search module 151 may be used to search for text, music, sound, image, video, and/or other files in memory 102 that match one or more search criteria (e.g., one or more user-specified search terms).

Each of the above identified modules and applications correspond to a set of instructions for performing one or more functions described above. These modules (i.e., sets of instructions) need not be implemented as separate software programs, procedures or modules, and thus various subsets of these modules may be combined or otherwise rearranged in various embodiments. In some embodiments, memory 102 may store a subset of the modules and data structures identified above. Furthermore, memory 102 may store additional modules and data structures not described above.

In some embodiments, device 100 is a device in which operation of a predefined set of functions on the device is performed exclusively through touch screen 112 and/or a touchpad. By using a touch screen and/or a touchpad as the primary input/control device for operation of device 100, the number of physical input/control devices (such as push buttons, dials, and the like) on device 100 may be reduced.

The predefined set of functions that may be performed exclusively through a touch screen and/or a touchpad includes navigation between user interfaces. In some embodiments, the touchpad, when touched by the user, navigates device 100 to a main, home, or root menu from any user interface that may be displayed on device 100. In such embodiments, the touchpad may be referred to as a “menu button.” In some other embodiments, the menu button may be a physical push button or other physical input/control device instead of a touchpad.

One or more Application Programming Interfaces (APIs) may be used in some embodiments. An API is an interface implemented by a program code component or hardware component (hereinafter “API-implementing component”) that allows a different program code component or hardware component (hereinafter “API-calling component”) to access and use one or more functions, methods, procedures, data structures, classes, and/or other services provided by the API-implementing component. An API can define one or more parameters that are passed between the API-calling component and the API-implementing component.

An API allows a developer of an API-calling component (which may be a third party developer) to leverage specified features provided by an API-implementing component. There may be one API-calling component or there may be more than one such component. An API can be a source code interface that a computer system or program library provides in order to support requests for services from an application. An operating system (OS) can have multiple APIs to allow applications running on the OS to call one or more of those APIs, and a service (such as a program library) can have multiple APIs to allow an application that uses the service to call one or more of those APIs. An API can be specified in terms of a programming language that can be interpreted or compiled when an application is built.

In some embodiments the API-implementing component may provide more than one API, each providing a different view of or with different aspects that access different aspects of the functionality implemented by the API-implementing component. For example, one API of an API-implementing component can provide a first set of functions and can be exposed to third party developers, and another API of the API-implementing component can be hidden (not exposed) and provide a subset of the first set of functions and also provide another set of functions, such as testing or debugging functions, which are not in the first set of functions. In other embodiments, the API-implementing component may itself call one or more other components via an underlying API and thus be both an API-calling component and an API-implementing component.

An API defines the language and parameters that API-calling components use when accessing and using specified features of the API-implementing component. For example, an API-calling component accesses the specified features of the API-implementing component through one or more API calls or invocations (embodied, for example, by function or method calls) exposed by the API and passes data and control information using parameters via the API calls or invocations. The API-implementing component may return a value through the API in response to an API call from an API-calling component. While the API defines the syntax and result of an API call (e.g., how to invoke the API call and what the API call does), the API may not reveal how the API call accomplishes the function specified by the API call. Various API calls are transferred via the one or more application programming interfaces between the calling (API-calling component) and an API-implementing component. Transferring the API calls may include issuing, initiating, invoking, calling, receiving, returning, or responding to the function calls or messages; in other words, transferring can describe actions by either of the API-calling component or the API-implementing component. The function calls or other invocations of the API may send or receive one or more parameters through a parameter list or other structure. A parameter can be a constant, key, data structure, object, object class, variable, data type, pointer, array, list or a pointer to a function or method or another way to reference a data or other item to be passed via the API.

Furthermore, data types or classes may be provided by the API and implemented by the API-implementing component. Thus, the API-calling component may declare variables, use pointers, use or instantiate constant values of such types or classes by using definitions provided in the API.

Generally, an API can be used to access a service or data provided by the API-implementing component or to initiate performance of an operation or computation provided by the API-implementing component. By way of example, the API-implementing component and the API-calling component may each be any one of an operating system, a library, a device driver, an API, an application program, or other module (it should be understood that the API-implementing component and the API-calling component may be the same or different type of module from each other). API-implementing components may in some cases be embodied at least in part in firmware, microcode, or other hardware logic. In some embodiments, an API may allow a client program to use the services provided by a Software Development Kit (SDK) library. In other embodiments an application or other client program may use an API provided by an Application Framework. In these embodiments, the application or client program may incorporate calls to functions or methods provided by the SDK and provided by the API, or use data types or objects defined in the SDK and provided by the API. An Application Framework may, in these embodiments, provide a main event loop for a program that responds to various events defined by the Framework. The API allows the application to specify the events and the responses to the events using the Application Framework. In some implementations, an API call can report to an application the capabilities or state of a hardware device, including those related to aspects such as input capabilities and state, output capabilities and state, processing capability, power state, storage capacity and state, communications capability, etc., and the API may be implemented in part by firmware, microcode, or other low level logic that executes in part on the hardware component.

The API-calling component may be a local component (i.e., on the same data processing system as the API-implementing component) or a remote component (i.e., on a different data processing system from the API-implementing component) that communicates with the API-implementing component through the API over a network. It should be understood that an API-implementing component may also act as an API-calling component (i.e., it may make API calls to an API exposed by a different API-implementing component) and an API-calling component may also act as an API-implementing component by implementing an API that is exposed to a different API-calling component.

The API may allow multiple API-calling components written in different programming languages to communicate with the API-implementing component (thus the API may include features for translating calls and returns between the API-implementing component and the API-calling component); however the API may be implemented in terms of a specific programming language. An API-calling component can, in one embodiment, call APIs from different providers such as a set of APIs from an OS provider and another set of APIs from a plug-in provider and another set of APIs from another provider (e.g. the provider of a software library) or creator of the another set of APIs.

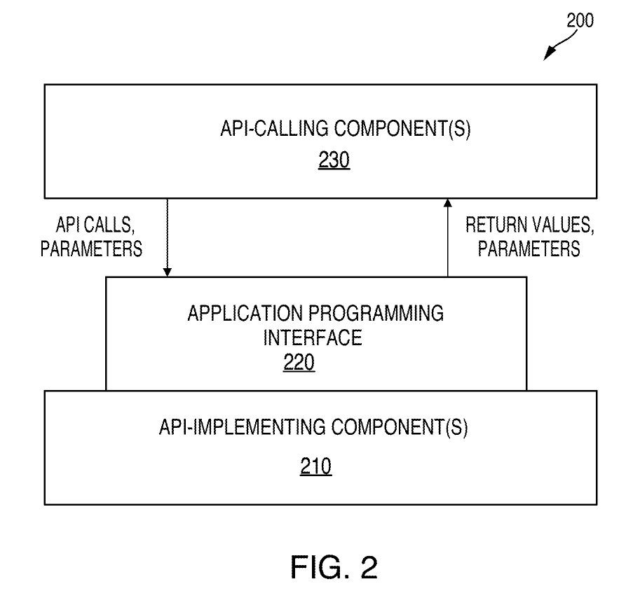

FIG. 2 is a block diagram illustrating an exemplary API architecture, which may be used in some embodiments of the invention. As shown in FIG. 2, the API architecture 200 includes the API-implementing component 210 (e.g., an operating system, a library, a device driver, an API, an application program, software or other module) that implements the API 220. The API 220 specifies one or more functions, methods, classes, objects, protocols, data structures, formats and/or other features of the API-implementing component that may be used by the API-calling component 230. The API 220 can specify at least one calling convention that specifies how a function in the API-implementing component receives parameters from the API-calling component and how the function returns a result to the API-calling component. The API-calling component 230 (e.g., an operating system, a library, a device driver, an API, an application program, software or other module) makes API calls through the API 220 to access and use the features of the API-implementing component 210 that are specified by the API 220. The API-implementing component 210 may return a value through the API 220 to the API-calling component 230 in response to an API call.

It will be appreciated that the API-implementing component 210 may include additional functions, methods, classes, data structures, and/or other features that are not specified through the API 220 and are not available to the API-calling component 230. It should be understood that the API-calling component 230 may be on the same system as the API-implementing component 210 or may be located remotely and accesses the API-implementing component 210 using the API 220 over a network. While FIG. 2 illustrates a single API-calling component 230 interacting with the API 220, it should be understood that other API-calling components, which may be written in different languages (or the same language) than the API-calling component 230, may use the API 220.

The API-implementing component 210, the API 220, and the API-calling component 230 may be stored in a machine-readable medium, which includes any mechanism for storing information in a form readable by a machine (e.g., a computer or other data processing system). Examples of machine-readable media include magnetic disks, optical disks, random access memory, read only memory, flash memory devices, etc.

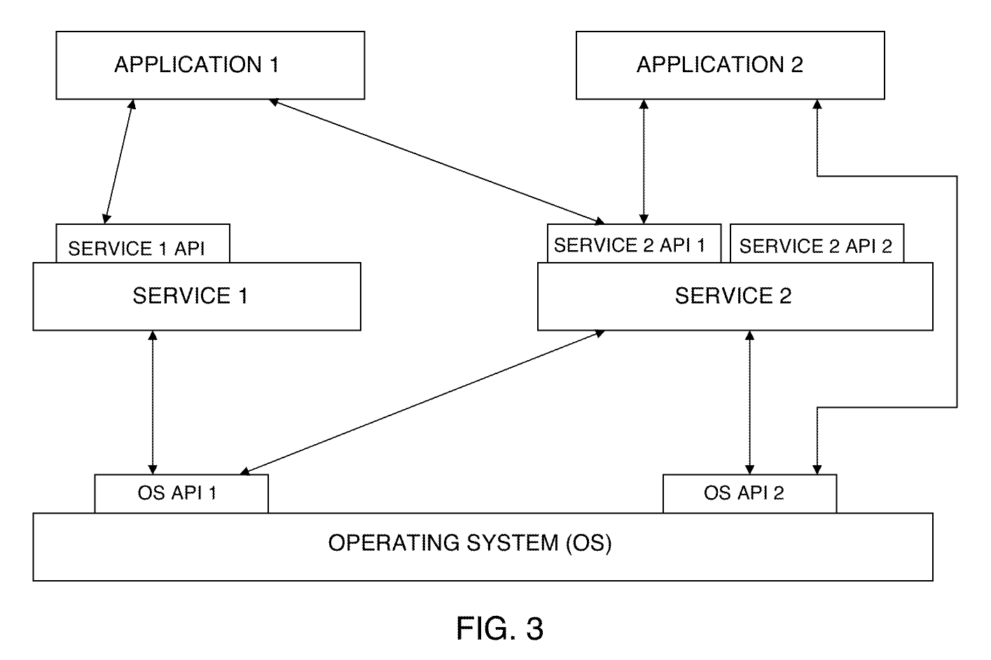

In FIG. 3 (“Software Stack”), an exemplary embodiment, applications can make calls to Services 1 or 2 using several Service APIs and to Operating System (OS) using several OS APIs. Services 1 and 2 can make calls to the OS using several OS APIs.

Note that the Service 2 has two APIs, one of which (Service 2 API 1) receives calls from and returns values to Application 1 and the other (Service 2 API 2) receives calls from and returns values to Application 2. Service 1 (which can be, for example, a software library) makes calls to and receives returned values from OS API 1, and Service 2 (which can be, for example, a software library) makes calls to and receives returned values from both OS API 1 and OS API 2. Application 2 makes calls to and receives returned values from OS API 2.

FIG. 4 illustrates a portable multifunction device 100 having a touch screen 112 in accordance with some embodiments. The touch screen may display one or more graphics. In this embodiment, as well as others described below, a user may select one or more of the graphics by making contact or touching the graphics, for example, with one or more fingers 402 (not drawn to scale in the figure). In some embodiments, selection of one or more graphics occurs when the user breaks contact with the one or more graphics. In some embodiments, the contact may include a gesture, such as one or more taps, one or more swipes (from left to right, right to left, upward and/or downward) and/or a rolling of a finger (from right to left, left to right, upward and/or downward) that has made contact with device 100. In some embodiments, inadvertent contact with a graphic may not select the graphic. For example, a swipe gesture that sweeps over an application icon may not select the corresponding application when the gesture corresponding to selection is a tap.

Device 100 may also include one or more physical buttons, such as “home” or menu button 404. As described previously, menu button 404 may be used to navigate to any application 136 in a set of applications that may be executed on device 100. Alternatively, in some embodiments, the menu button is implemented as a soft key in a GUI in touch screen 112.

In one embodiment, device 100 includes touch screen 112, menu button 404, push button 406 for powering the device on/off and locking the device, and volume adjustment button(s) 408. Push button 406 may be used to turn the power on/off on the device by depressing the button and holding the button in the depressed state for a predefined time interval, to lock the device by depressing the button and releasing the button before the predefined time interval has elapsed, and/or to unlock the device or initiate an unlock process. In an alternative embodiment, device 100 also may accept verbal input for activation or deactivation of some functions through microphone 113.

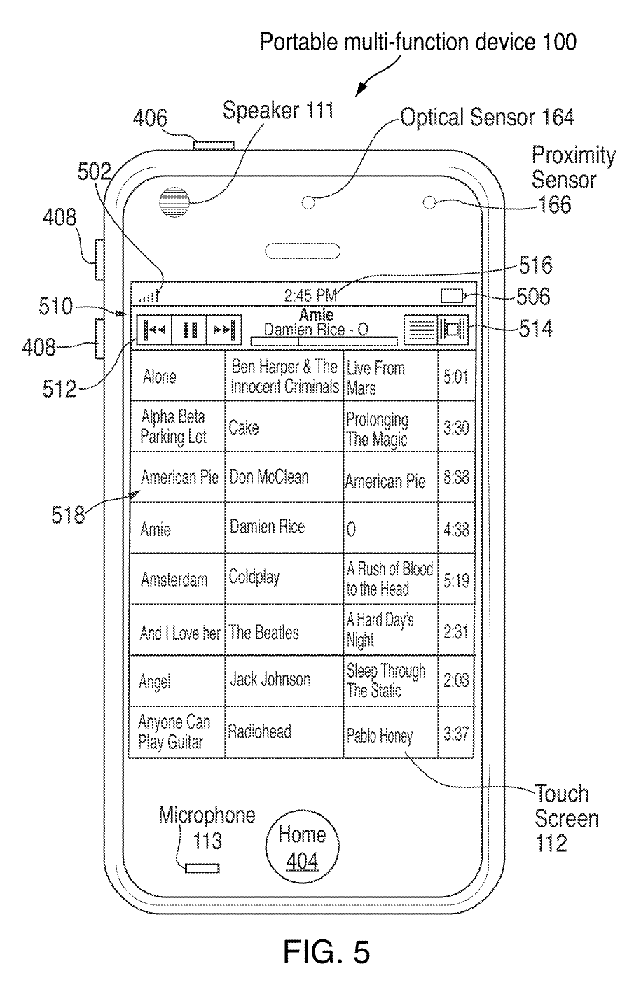

Attention is now directed towards embodiments of user interfaces (“UI”) and associated processes that may be implemented on a portable multifunction device 100. FIG. 5 illustrates an exemplary user interface for controlling media playback on a portable electronic device in accordance with some embodiments. In some embodiments, user interface 500 includes the following elements, or a subset or superset thereof:
signal strength indicator 502 for wireless communication;
time 504;
battery status indicator 506;
banner 510 with the following media control items:
   playback control button 512;
   currently-playing media display 516; and
   media playlist view button 514; and
media playlist list view 518.

Playback control button 512 can include a number of playback control icons including ‘back,’ ‘pause,’ and ‘next,’ which are shown in the left, center, and right sections of button 512, respectively. If the ‘pause’ icon is shown, that may indicate that device 100 is currently playing a media file. At times that device 100 is not playing a media file, the center icon of button 512 may display a ‘play’ button instead. Currently-playing media display 516 may, according to some embodiments, display the name and other identifying information about the currently-playing media file. Display 516 can also include a status bar, which indicates progress through the currently-playing media file. Media playlist view button 514 can include options to switch between different available media playlist view modes. For example, button 514 includes ‘list’ mode on the left and ‘album-art’ mode on the right. The list icon is shaded, indicating that the device is currently in list mode. Tapping the album-art icon may change the device from list mode to album-art mode.

With the device in list mode, media playlist view 518 will be displayed in user interface 500. Media playlist view 518 provides the user with a list of information relating to media files, including but not limited to, Title, Artist, Album, and length. According to some embodiments, media files in view 518 may be part of a playlist. Playlists may be user created or generated automatically. For example, the user may choose to play songs from one particular artist, in which case a playlist can be generated of all available songs from that artist, or the user may choose one particular media file and let device 100 automatically populate a playlist with similar media files (i.e., a ‘Genius Mix’). In the event that all files in the current playlist do not fit in view 518, a user can access the rest of the files by scrolling up and down the list. A user may scroll up and down by performing a swiping gesture on user interface 500. User interface 500 is displayed in a portrait orientation; however, user interface 500 can be displayed in landscape mode. For example, using accelerometer 168, device 100 can detect a change in its orientation and adjust the user interface accordingly.

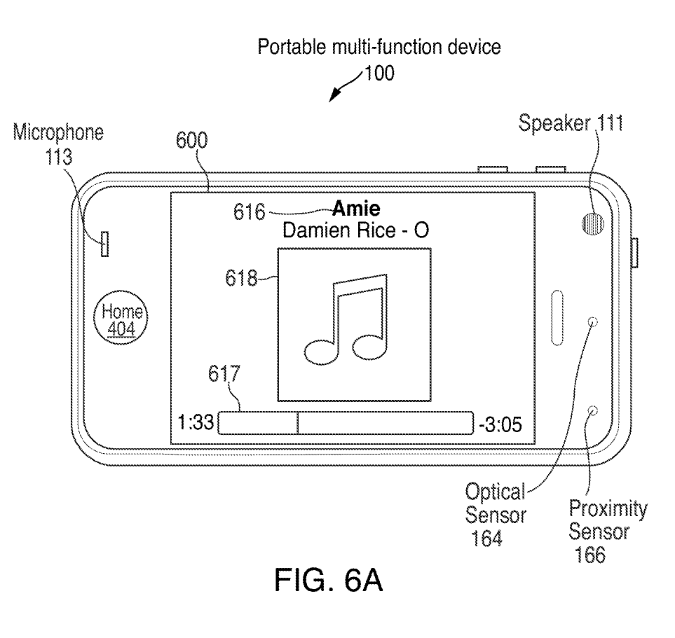

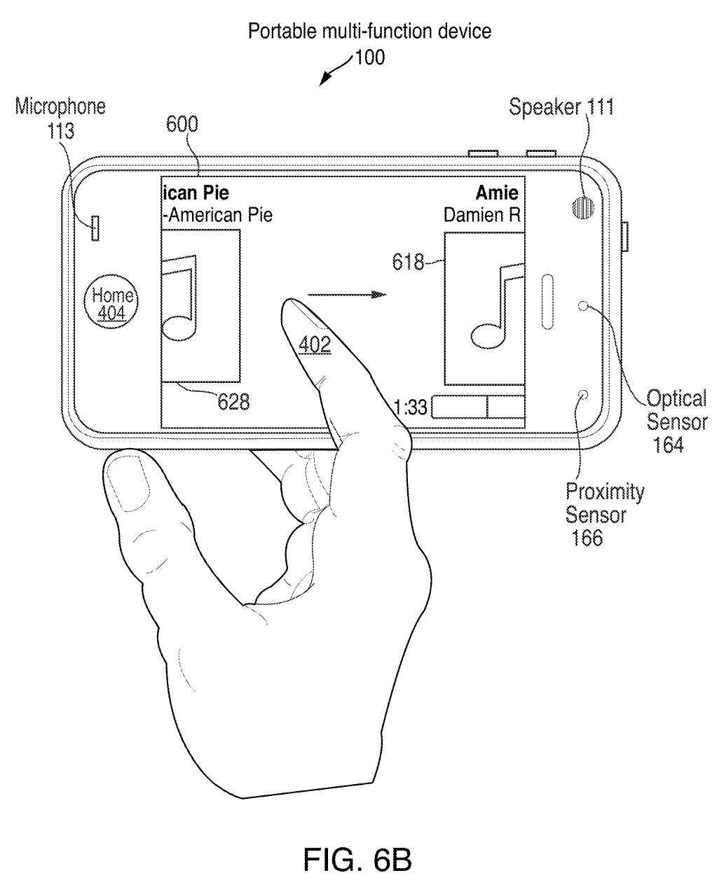

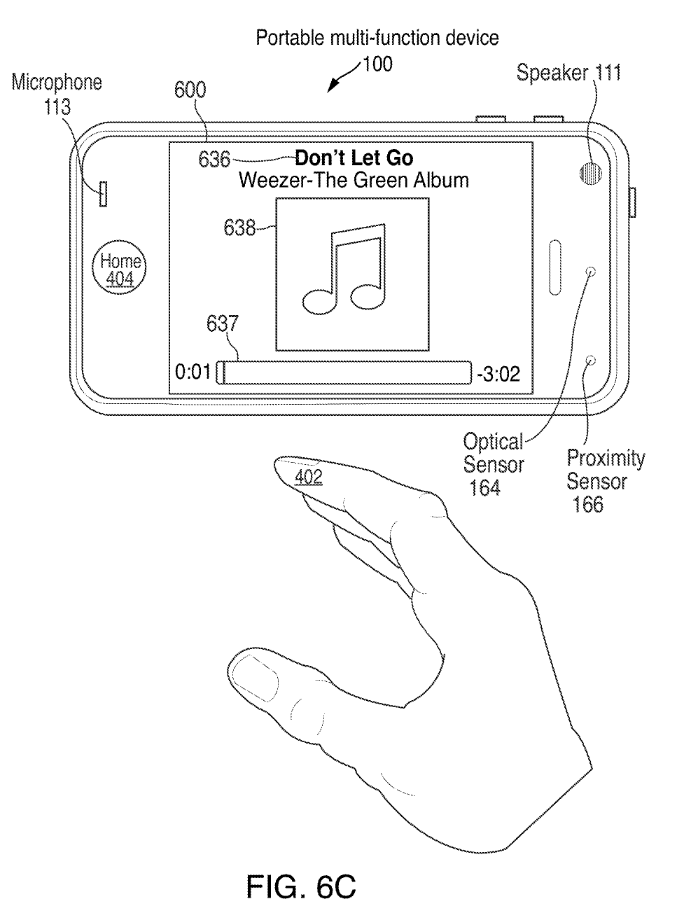

FIG. 6A illustrates an exemplary user interface 600 for controlling media playback on a portable electronic device in accordance with some embodiments. User interface 600 may be displayed when the electronic device is in album-art mode. The device may enter album-art mode if a user taps the album-art icon in button 514 of FIG. 5, for example. User interface 600 may include a media tile associated with a particular media file, including a subset or superset of the following elements: currently-playing media display 616; status bar 617; and album art 618. In some embodiments, only album art 618 may be displayed in the media tile of user interface 600. Album art 618 can be any suitable graphic associated with the currently-playing media file. For example, album art 618 can be the art displayed on the front cover of the album on which the currently-playing media file was released. In further examples, album art 618 can be a still image (e.g., a photograph), the cover art for a video (e.g., the cover art for a DVD), or a screen shot or video clip from a video file. Album art may be downloaded to device 100 automatically through an album-art application, manually provided by the user, or procured by any other suitable method.

FIG. 6B illustrates an exemplary user interface 600 for controlling media playback on a portable electronic device in accordance with some embodiments. User interface 600 of FIG. 6B shows a user using a gesture to scroll through a set of media tiles while in album-art mode, in accordance with some embodiments. In some embodiments, the gesture may be a quick view gesture, which can put device 100 into quick view gesture mode. In addition to currently-playing media display 616, status bar 617, and album art 618, media display 626 and album art 628 are also visible on user interface 600.

User interface 600 can allow a user to scroll through a playlist (e.g., the playlist that is partially displayed in user interface 500 of FIG. 5) and potentially select a new media file to play. For example, user interface 600 shows a user making a swiping quick view gesture from left to right using finger 402. As the user swipes from left to right, the media tile including album art 628 and media display 626 associated with the previous media file in the playlist (i.e., American Pie by Don McLean) can come into view. The speed at which the elements on user interface 600 slide from left to right can depend, in some embodiments, on the speed with which the user swipes his or her finger. For example, a dragging quick view gesture may slide the elements on user interface 600 at the same speed and over the same distance as the dragged finger. A dragging quick view gesture may be valuable for taking a quick peek at the next (or previous, depending on which direction the user dragged his or her finger) media tile.

A user can continue to scroll left or right through the playlist by continuing to swipe finger 402 in the desired direction in order to remain in quick view gesture mode. So, for example, if a user continues to swipe from left to right on user interface 600 of FIG. 6B, the media tile associated with Alpha Beta Parking Lot by Cake will come into view (assuming that the currently loaded playlist is the one partially displayed in user interface 500 of FIG. 5). Likewise, a user can swipe from right to left, which would bring the media tile associated with Amsterdam by Coldplay into view. In this manner a user can scroll through the media tiles associated with all media files in the currently loaded playlist. Any suitable animation may be used to transition from one media tile to the next. For example, the media tiles can move in a sliding motion or with a page-flipping motion, etc.

It is to be understood that the gestures described above are only a few examples of possible gestures appropriate for scrolling through a playlist in album-art mode. According to other embodiments, other suitable gestures, including using a ‘walking’ gesture with two or more fingers, may be employed.

According to some embodiments, as long as a user continues to scroll from one media tile to the next, playback of the currently-playing media file (i.e., Amie by Damien Rice) will not be disturbed and device 100 will remain in quick view gesture mode. However, a user may indicate his or her desire to switch to a different media file in the currently loaded playlist by stopping on the media tile corresponding to the desired media file and ending quick view gesture mode. In some embodiments, the currently-playing media file will continue to play as long as finger 402 is in contact with user interface 600. In those embodiments, if finger 402 is removed from user interface 600 for a predetermined period of time (e.g., one second), quick view gesture mode can end and device 100 may begin playing back the media file associated with the tile currently being displayed. In other embodiments, if a user stops scrolling through the currently loaded playlist for a predetermined period of time (e.g., 3 seconds) at a particular media tile, the media file associated with that media tile will begin playing even if finger 402 is still in contact with user interface 600.

In the event that the currently loaded playlist contains a large number of media files, it may be necessary to provide a shortcut back to the media tile associated with the currently-playing media file. For example, a user may scroll through 50 media tiles before deciding not to select a new media file to play. Rather than scrolling back through all 50 media file displays to return to the currently-playing media file, a user can use a shortcut. The shortcut may take any suitable form, including a particular gesture (e.g., swiping finger 402 in an upwards direction or swiping two or more fingers in the direction of the media tile associated with the currently-playing media file) or a virtual button. In some embodiments, the shortcut can be achieved by pressing home button 404. In those embodiments, a user can enter and exit quick view gesture mode without disrupting the currently playing media file.

A user may also use a series of gestures to reorder the currently loaded playlist while in album-art mode. For example, a user can scroll to a particular media tile that he or she wishes to requeue, and select the media tile for requeuing by performing a gesture (e.g., making a pinching motion on the album art). The user can then scroll to the desired position in the playlist and place the media tile in that position (e.g., by making a reverse pinching gesture).

FIG. 6C illustrates an exemplary user interface 600 for controlling media playback on a portable electronic device in accordance with some embodiments. User interface 600 shows the result of a user selecting a new media file from a currently loaded playlist while in album-art mode and includes a media tile, including media display 636, status bar 637, and album art 638. In the event that the currently loaded playlist (i.e., the playlist partially displayed in user interface 500 of FIG. 5) is in alphabetical order according to media file name, a user would have eventually arrived at the media tile by continuing to swipe finger 402 from right to left on user interface 600. Upon selecting the media file represented by media display 636 and album art 638 (e.g., by lifting finger 402 off of user interface 600, or by waiting a predetermined period of time), device 100 can begin playback of the new media file (e.g., through headphones attached to a headphone jack or through speaker 111).

According to some embodiments, playback of the new media file may not begin immediately. For instance, device 100 may gradually fade out the currently-playing media file and fade in the new media file. If the media files are audio files, fading out and in may include lowering and raising the volume. In the event that the media files are video files, fading out and in may also include fading a video signal out and in. Device 100 may also seamlessly fade from one media file to another by gradually matching the beats between the two files. For example, if the first media file is an audio file with a tempo of 120 beats per minute (“bpm”) and the second media file has a tempo of 130 bpm, device 100 may gradually speed up the first media file to match the second, play both files simultaneously for a period of time, and finally fade out the first media file.

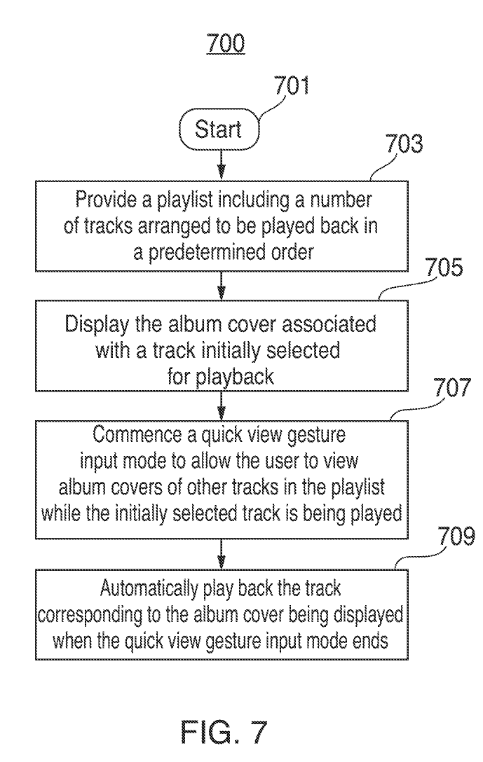

FIG. 7 is a flow diagram illustrating process 700 for controlling media playback on a portable electronic device in accordance with some embodiments. Process 700 begins at step 701 and proceeds to step 703 in which a playlist including a number of tracks arranged to be played back according to a predetermined order can be provided. Each track can have an associated album cover. At step 705, device 100 can enter a playback mode in which the album cover associated with a track initially selected for playback can be displayed. At step 707, a quick view gesture input mode can be commenced on device 100. The quick view gesture mode can allow the user to view the album covers of other tracks in the playlist while the initially selected track is being played. For example, a user may perform a swiping, dragging, or walking gesture to view the album covers of other tracks. Process 700 can then automatically play back the track corresponding to the album cover being displayed when the quick view gesture input mode ends at step 709. The quick view gesture input mode may end in a number of suitable ways, including waiting a predetermined length of time after a last quick view gesture has been completed.

It is to be understood that the steps shown in process 700 are merely illustrative and that existing steps may be modified or omitted, additional steps may be added, and the order of certain steps may be altered.

Moreover, the method described with respect to FIG. 7, as well as any other aspects of the invention, may each be implemented by software, but may also be implemented in hardware, firmware, or any combination of software, hardware, and firmware. They each may also be embodied as machine-readable code recorded on a machine-readable medium. The machine-readable medium may be any data storage device that can store data that can thereafter be read by a computer system. Examples of the machine-readable medium may include, but are not limited to, read-only memory, random-access memory, flash memory, CD-ROMs, DVDs, magnetic tape, and optical data storage devices. The machine-readable medium can also be distributed over network-coupled computer systems so that the machine-readable code is stored and executed in distributed fashion.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A portable multifunction device, comprising:
a display;
one or more processors;
a memory; and
one or more programs, wherein the one or more programs are stored in the memory and configured to be executed by the one or more processors, the programs including instructions for:
playing back a media file initially selected from a media playlist, each media file in the media playlist having an associated media tile and is arranged to be played back in a predetermined order;
displaying the media tile associated with the initially selected media file;
receiving one or more quick view gestures to change the media tile being displayed, wherein each received quick view gesture either advances display of the media tile corresponding to a next media file or a previous media file in the playlist;
continuing playback of the initially selected media file while the one or more quick view gestures are being received; and
upon a determination that the one or more quick view gestures are no longer being received, automatically playing back the media file corresponding to the displayed media tile.

2. The portable multifunction device of claim 1, wherein the display is a touch-sensitive screen.

3. The portable multifunction device of claim 2, wherein the quick view gesture is performed on the touch-sensitive screen.

4. The portable multifunction device of claim 3, wherein the gesture comprises a swiping gesture made by at least one finger.

5. The portable multifunction device of claim 3, wherein the gesture comprises a walking gesture made by at least two fingers.

6. The portable multifunction device of claim 1, wherein automatically playing back the media file corresponding to the displayed media tile comprises waiting a predetermined length of time after displaying the second media tile.

7. The portable multifunction device of claim 2, wherein automatically playing back the media file corresponding to the displayed media tile comprises determining that a user has lifted a finger off of the display of the touch-sensitive screen.

8. A computer-implemented method, comprising:
providing a playlist including a plurality of tracks arranged to be played back according to a predetermined order, and wherein each of the tracks has an associated album cover; and
in a playback mode in which the album cover associated with a track initially selected is displayed,
commencing a quick view gesture input mode that allows the user to view the album covers of other tracks in the playlist while the initially selected track is being played; and
automatically playing back the track corresponding to the album cover being displayed when the quick view gesture input mode ends.

9. The computer-implemented method of claim 8, wherein the allowing the user to view the album covers of other tracks comprises scrolling through the album covers of other tracks using a plurality of quick view gestures.

10. The computer-implemented method of claim 9, wherein the quick view gesture input mode ends a predetermined length of time after the last quick view gesture of the plurality of quick view gestures is completed.

11. The computer-implemented method of claim 10, wherein the plurality of quick view gestures comprises a swiping gesture on a touch-sensitive screen.

12. The computer-implemented method of claim 10, wherein the plurality of quick view gestures comprises a walking gesture on a touch-sensitive screen.

13. The computer-implemented method of claim 10, wherein the predetermined length of time is less than three seconds.

14. The computer-implemented method of claim 8, wherein automatically playing back the track comprises:
gradually fading out the first media file; and
gradually fading in the second media file.

15. The computer-implemented method of claim 8, wherein automatically playing back the track comprises:
gradually matching the tempo of the first media file to the tempo of the second media file;
playing both the first and second media files for a predetermined period of time; and
gradually reducing the volume of the first media file until it is no longer audible.

16. A portable multifunction device with a display, comprising:
circuitry operative to:
display a media tile comprising at least one of:
a currently-playing media display associated with a media file;
a status bar; and
album art; and
detect at least one gesture while the media tile is displayed;
enter into a quick view gesture mode and display a second media tile in response to the detected at least one gesture, the second media tile corresponding with a second media file;
exit the quick view gesture mode after a predetermined period of time has lapsed after a gesture has been detected; and
automatically plays the second media file.

17. The portable multifunction device of claim 16, wherein the display is a touch-sensitive screen.

18. The portable multifunction device of claim 17, wherein the at least one gesture is performed on the touch-sensitive screen.

19. A portable multifunction device,
comprising:
a display;
one or more processors;
a memory; and
one or more programs, wherein the one or more programs are stored in the memory and configured to be executed by the one or more processors, the programs including instructions for:
displaying a first media tile associated with an initially selected media file, wherein the media tile comprises at least one of:
a currently-playing media display associated with a media file;
a status bar; and
album art; and
displaying a second media tile in response to detecting at least a first gesture by a user of the device;
selecting the second media tile in response to detecting at least a second gesture by a user of the device; and
requeuing the second media tile in response to detecting at least a third gesture by a user of the device.

20. The device of claim 19, wherein:
the first gesture comprises a swiping gesture;
the second gesture comprises a pinching gesture; and
the third gesture comprises reverse-pinching gesture.
